(19) United States
(12) Patent Application Publication
(10) Pub. No.: US 2015/0032591 A1
(43) Pub. Date: Jan. 29, 2015

(54) COLLATERAL SEGREGATION, ALLOCATION, AND MANAGEMENT SYSTEM AND METHOD

(71) Applicant: THE BANK OF NEW YORK MELLON, New York, NY (US)

(72) Inventor: Outhicamannil Sam Jacob, Riverside, CT (US)

(21) Appl. No.: 13/951,920

(22) Filed: Jul. 26, 2013

(51) Int. Cl. G06Q 40/04

(52) U.S. Cl. CPC G06Q 40/04
USPC 705/37

(57) ABSTRACT

A system for managing collateral in one or more financial transactions includes one or more processors, at a securities intermediary to the one or more financial transactions, configured to execute one or more computer program modules. The program modules are configured to establish an individual segregated account for each of a plurality of pledgors, receive a lock-up amount from one or more secured parties for one of the plurality of pledgors, receive a request to post collateral from an account of the one of the plurality of pledgors to the individual segregated account associated with the one of the plurality of pledgors, and allocate collateral from the account of the one of the plurality of pledgors to the individual segregated account associated with the one of the plurality of pledgors, for the benefit of the one or more secured parties, the collateral being at least equal to the lock-up amount.

### BACKGROUND

This application is directed to computer-implemented systems and methods useful for segregating, allocating, and managing collateral (e.g., positions) in financial transactions. While aspects of this application may be associated with various types of collateral segregation and allocations, the computerized systems and methods for allocating collateral described herein may be in reference to financial transactions between collateral agents, futures commission merchants, end clients, and central clearing counterparties.

Virtually any security may be employed as collateral, including but not limited to Treasury or Government bills, corporate and Treasury/Government bonds, stocks/shares, or other securities or financial instruments, including cash.

Among other things, what is needed is a system and method for segregating, allocating, and managing collateral in financial transactions, simplifying and improving the allocations of collateral between market participants.

### SUMMARY

Various embodiments of this disclosure may be used in conjunction with existing financial services platforms, for example the Bank of New York Mellon's Tri-Party repurchase agreement products (RepoEdge®) which allow clients to outsource the operational aspects of their collateralized transactions, and Derivatives Margin Management (DM Edge), which helps clients manage credit risks associated with derivatives transactions by enabling them to accept, monitor and re-transfer collateral. These services, among others such as Repo Margin Management (RM Edge®), MarginDirect^{SM}, and Derivatives Collateral Net (DCN), may be delivered to clients through AccessEdge^{SM}, a real-time, web-based portal.

The operator/manager of the system and method of this disclosure may act as a third-party service provider to other market participants associated with the financial transactions, and the various functions performed by the system and method may provide value-added services which mitigate risk and lead to greater efficiencies for the other parties.

According to an embodiment, a system for managing collateral in one or more financial transactions includes one or more processors, at a securities intermediary to the one or more financial transactions, the one or more processors configured to execute one or more computer program modules. The program modules are configured to establish an individual segregated account for each of a plurality of pledgors, receive a lock-up amount from one or more secured parties for one of the plurality of pledgors, receive a request to post collateral from an account of the one of the plurality of pledgors to the individual segregated account associated with the one of the plurality of pledgors, and allocate collateral from the account of the one of the plurality of pledgors to the individual segregated account associated with the one of the plurality of pledgors, for the benefit of the one or more secured parties, the collateral being at least equal to the lock-up amount.

According to another embodiment, a computer implemented method for managing collateral in one or more financial transactions, wherein the method is implemented in a computer system comprising one or more processors configured to execute one or more computer program modules, includes establishing, via the one or more processors, at a securities intermediary to the one or more financial transactions, an individual segregated account for each of a plurality of pledgors. The method also includes receiving, via the one or more processors, a lock-up amount from one or more secured parties for one of the plurality of pledgors. The method also includes receiving, via the one or more processors, a request to post collateral from an account of the one of the plurality of pledgors to the individual segregated account associated with the one of the plurality of pledgors. The method further includes allocating collateral from the account of the one of the plurality of pledgors to the individual segregated account associated with the one of the plurality of pledgors, for the benefit of the one or more secured parties, the collateral being at least equal to the lock-up amount.

The system and method of this disclosure provides various capabilities as discussed more fully in the detailed description below.

### BRIEF DISCUSSION OF THE DRAWINGS

FIGS. 1A and 1B provide functional block diagrams of embodiments of a computer-implemented and networked system for collateral management;

FIGS. 2A and 2B illustrate an exemplary process flow over time for a plurality of participants utilizing the system for collateral management;

FIG. 3 illustrates an exemplary flowchart associated with the collateral movements; and

FIG. 4 illustrates an exemplary system diagram configured to implement an embodiment of the system for collateral management.

### DETAILED DESCRIPTION

In the discussion of various embodiments and aspects of the system and method of this disclosure, examples of a processor may include any one or more of, for instance, a personal computer, portable computer, personal digital assistant (PDA), workstation, or other processor-driven device, and examples of network may include, for example, a private network, the Internet, or other known network types, including both wired and wireless networks.

Those with skill in the art will appreciate that the inventive concept described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

Described herein is an exemplary system which may be implemented through computer software running in a processor to coordinate collateral segregation, management, and allocations across system participants. This description is not intended to be limiting, but is merely provided to describe one way of accomplishing the functions associated with determining the desired collateral segregation, management, and allocations.

In the discussion of various embodiments and aspects of the system and method of this disclosure, examples of trading parties include, but are not limited to, broker-dealers, institutional investors, hedge fund managers, futures commission merchants, and central counterparties.

In various embodiments, a web-based collateral management system or platform links dealers with investors to conduct collateral transactions in a safe, efficient, and reliable way. Pledgors and secured parties can manage collateral among a diverse range of instruments, including agreements in all major currencies, securities lending transactions, municipal deposits, bank loans, derivatives transactions, letters of credit, and structured trades, for example. The system may be managed by the collateral agent, and may additionally provide, for example, daily mark-to-market valuations, haircuts/margins, and concentration limits (i.e., maintain percentages of market capitalization, dollar amount limits for a particular security, or a percentage of the portfolio in a particular security, for example), as well as manage, track, and settle collateral transactions across global capital markets by working collaboratively with clients to provide collateral transparency.

As described in greater detail below, it may be appreciated that in an embodiment a pledgor may be a dealer representing underlying clients. Similarly, in an embodiment, a pledgor may be one of the clients of dealer (e.g., may be a fund or similar party). Likewise, in an embodiment, the pledgor may be an independent party pledging directly to a secured party.

According to various embodiments, a securities intermediary may function as a collateral agent to establish individual segregated accounts for each of a dealer's underlying client pledgors cleared over the counter (OTC) initial margin obligations for derivatives trades cleared via a futures commission merchant as the clearing member at a secured party such as a central clearing counterparty. In an embodiment, the securities intermediary may comprise a neutral counterparty in the transaction. The dealer may direct each client pledgor (e.g., funds) to post the required initial margins (and any excess) to the segregated accounts established at the securities intermediary. In an embodiment, the collateral posted at the individual segregated account may be for the benefit of the secured party (e.g., the central clearing counterparty). The pledgor may choose to maintain excess collateral in the segregated account in excess of any lock-up amount requirements, and the pledgor may maintain excess collateral in their individual account which may be used for allocations of collateral to any number of individually segregated accounts. The pledgor may also choose to confirm lock-up requirements. In an embodiment, each of a plurality of parties (e.g., one or more pledgors and one or more secured parties) may specify a proposed lockup amount for each individual segregated account, which may be matched, agreed to, and established automatically by the securities intermediary, based on instructions from the associated parties.

Each individual account for an underlying client may be used to meet obligations for various secured parties. The requirements for each individually segregated account may be determined by the secured party or a combination of secured parties, which may be a central clearing counterparty solely, or a central clearing counterparty and a futures commission merchant, for example, and the associated lock-up amount may be provided to the securities intermediary. When there is sufficient eligible collateral to meet the lock-up obligation of the secured party, the securities intermediary may segregate collateral into an individually segregated account associated with the respective secured party, who may be a central clearing counterparty, a futures commission merchant, or any other person or institution. It may be appreciated that eligibility may be determined not only by quantity of collateral, but also in some embodiments by meeting eligibility criteria based on agreements between the associated pledgors and secured parties managed via rule sets as defined by the collateral management system. In some embodiments, such segregation may be characterized as an internal allocation within the securities intermediary. Such allocations may occur at pre-determined times. Once collateral has been segregated and locked up, a change in lock-up amount values may be determined by the secured party, with conditional or unconditional substitutions potentially permitted, as described in greater detail below. It may be appreciated that in an embodiment the securities intermediary may establish individual margin accounts for each of the pledgors, associated with a global settlement platform, as well as individual margin accounts for each of the pledgors associated with obligations from the secured party. In an embodiment, the securities intermediary may establish segregated accounts for each of the pledgors, to fulfill obligations to the secured party (central clearing counterparty) for the futures commission merchant and/or for other clearing members and central clearing counterparties and or other persons or institutions. The secured party may provide a lockup amount for which the individually segregated account will be collateralized by the pledgor,

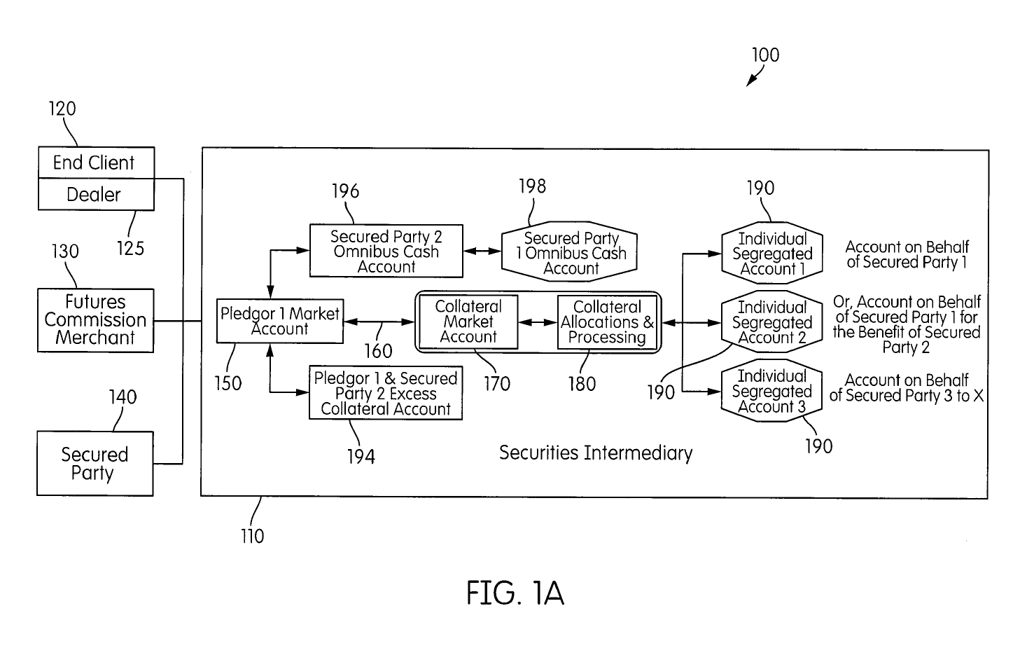

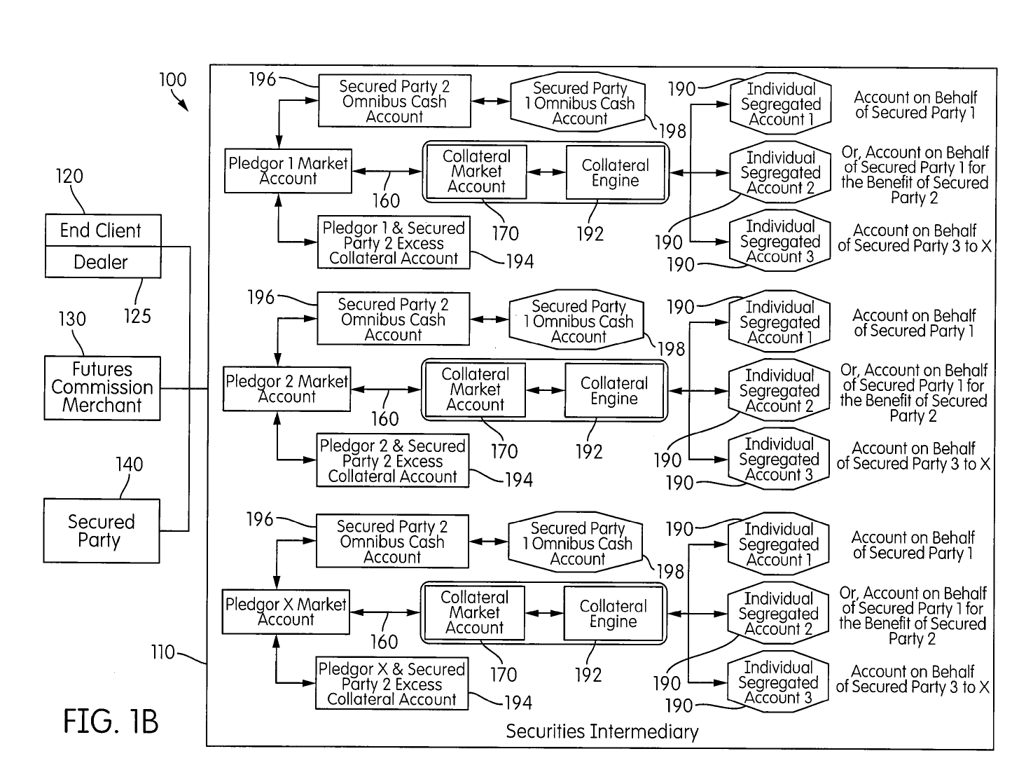

FIGS. 1A and 1B illustrate flowchart diagrams of embodiments of a collateral management system 100. Collateral management system 100 is configured to provide an interface, hosted by a securities intermediary 110, between end clients 120 (e.g., via a dealer 125), futures commission merchants 130 (e.g., clearing members), and secured parties 140. It may be appreciated that such an interface may be configured to provide individual account segregation for initial margins posted for cleared OTC derivatives trades or other financial transactions. Such an arrangement may allow parties to avoid risks associated with comingling their posted margins with that of fellow participants, and may protect collateral posted as margins in the event of a default by a secured party such as the futures commission merchants 130 or a central clearing counterparty. For example, any given end client 120 (as a pledgor) may know at a given time the location of their collateral, over such collateral being comingled with the assets of other clients (which may prevent their access and transparency into the account).

The securities intermediary 110 may be configured to function as a collateral agent to establish individual segregated accounts (ISAs) for each of the end clients 120. It may be appreciated that the end clients 120 may be the underlying pledgors (e.g., funds) associated with the dealer 125. In an embodiment, the individual segregated accounts provided by the securities intermediary 110 may be for the cleared OTC initial margin obligations of the end clients 120. In an embodiment, such initial margin obligations may be for trades cleared via a futures commission merchant 130 (e.g., a clearing broker) acting as a clearing member at a secured party 140. As described in greater detail below, in some embodiments the dealer 125 may utilize an intermediary to instruct their trades. For example, the dealer 125 may instruct the intermediary to deliver (free/unallocated) required and excess margin collateral in securities and/or wire cash into each customer's account.

In an embodiment, the dealer 125 may direct each end client 120 (e.g., each fund) to post required initial margins (and any excess) to the segregated accounts established at the securities intermediary 110. In an embodiment, the dealer 125 may choose to maintain excess collateral in the segregated account at the securities intermediary 110 in excess of any lock-up amount requirements. In some embodiments, the dealer 125 may choose to confirm the lock-up requirements. It may be appreciated that each individual account for an underlying end client 120 may be used to meet obligations for various clearing members (e.g., the futures commission merchants 130).

In an embodiment, the requirements for each pledgor (e.g., each end client 120) may be determined by the secured party 140, which may provide such information to the securities intermediary 110. In an embodiment the requirements for each pledgor determined by the secured party 140 may include the associated lock-up amount. Where there is sufficient eligible collateral associated with the pledgor at the securities intermediary 110 to meet the lock-up obligation determined by the secured party 140, the securities intermediary 110 may segregate collateral in an individual segregated account associated with the end client 120/dealer 125, futures commission merchant 130, and secured party 140. In various embodiments, the allocation of collateral to the segregated account may occur unilaterally based on instructions from the secured party 140 (or secured parties 140), or bilaterally based on instructions from both the one or more pledgors and the one or more secured parties 140. In an embodiment, the collateral segregation in the individual segregated account may be performed at pre-determined times. It may be appreciated that the times may vary in some embodiments, and may be at any appropriate convenient time, including as described in greater detail below. In an embodiment, once collateral has been segregated and locked up by the securities intermediary 110, any change in the lock-up amount value might be determined by the secured party 140. In an embodiment, substitutions may be permitted on a “get before you give” basis, e.g., where new collateral is received first before old collateral is released, so long as collateral eligibility criteria are met. As an example, if a pledgor wanted to recall a security that was locked up in an individually segregated account, they could deliver eligible amount of cash or securities, including a combination of both, into their margin account from where the newly received items may be validated against a pre-determined rule set to meet eligibility criteria. If the collateral eligibility criteria is met, the collateral may be allocated to the individually segregated account, at which point the recalled security may then be considered to be in excess of the lock-up amount and may be returned to the pledgors individual margin account. In an embodiment, substitutions may be allowed as long as collateral is not moved between the segregated accounts. Accordingly, to facilitate the get before you give model, with no credit provided, lock-up accounts (recall/stale) may be set up in the name of the secured party 140 to ensure that the secured party 140 remains secured throughout the substitution process. In an embodiment, upon collateralization of a collateral account of the secured party 140, the secured party 140 may be over-allocated, as the securities in the lock-up account may be in the name of the secured party 140 as well. In an embodiment, the securities intermediary 110 may de-pledge the position equivalent to the recalled securities, and release the recall. In an embodiment, upon settlement of the securities back to the dealer 125, the recalled securities in the recall lockup may then be removed.

In an embodiment, the workflow of the collateral management system 100 may proceed with the secured party 140 calculating margin requirements based on outstanding positions. In some embodiments, the central clearing counterparty may notify the futures commission merchant 130 and/or the dealer 125 of an instruction matching requirement, such as that implemented through automated deal matching. In some embodiments the futures commission merchant 130 may notify the dealer 125. In an embodiment, one or more of the notifications may be through the securities intermediary 110. In an embodiment, the dealer 125 may confirm with the futures commission merchant 130 the amount, including any excess. The futures commission merchant 130 may then notify the secured party 140 of the instruction matching amount, including the excess. Accordingly, in an embodiment the futures commission merchant 130 may keep the dealer 125 appraised of the exposure at the secured party 140. In an embodiment, the future commission merchant 130 may be the dealer 125. Likewise, in some embodiments, the client may be a manager for an underlying client. In an embodiment, the securities intermediary 110 may then create segregated collateral accounts for each pledgor. In an embodiment, the secured party 140 may enter the lock-up amount for each respective pledgor at the fund level. In an embodiment, the securities intermediary 110 may match the lock-up amount between the plurality of pledgors and secured parties. The time frame for such actions may vary across embodiments. In some embodiments, the instructions established by the secured party 140 may be unilateral. In other embodiments, the instructions may be bilateral, and the pledgor (e.g., the end client 120) may confirm the instructions. It may be appreciated that the designation of the lock-up amount and/or the confirmation thereof may be via the securities intermediary 110, including via a graphical user interface associated with a network connection between the participants.

Based on the lock-up amount established by the secured party 140, the end clients 120 may then direct their custodians to deliver free eligible collateral to the securities intermediary. In some embodiments, the end clients 120 may deliver the collateral, or instruct delivery of the collateral, via the dealer 125. In an embodiment, the collateral may be stored in pledgor market accounts 150. In various embodiments, collateral types may include FED (Federal Reserve), DTC (Depository Trust Corporation), Global, cash, multi-currency, and/or any other appropriate collateral configuration. In an embodiment, cash and money funds will be treated as acceptable collateral. In an embodiment, where the dealer 125 or underlying end clients 120 have collateral in an existing custody account (e.g., at the securities intermediary 110), intraday rehypothecation or similar transfers may allow direct allocation of those assets to the secured party 140 (e.g., the secured party). It may be appreciated that such a transfer may bypass setting up a separate margin account. In an embodiment, the securities intermediary 110 may pre-screen eligible collateral. For example, the securities intermediary 110 may ensure that the assets are fully paid for and unencumbered.

In an embodiment, the pledgor market account 150 may be established by the pledgor at the securities intermediary. In an embodiment, the pledgor market accounts 150 may be used by the pledgor to deliver in collateral which may be used to fulfill obligations to one or more secured parties. It may be appreciated that in an embodiment the deliveries may come in Receive versus Free (RVF), while recalls may be processed Deliver versus Free (DVF). In an embodiment the market account 150 may be considered under the control of the pledgor (e.g., solely under the control of the pledgor), or may be linked thereto. In an embodiment, the collateral management system 100 may be configured to utilize the market account 150 to meet collateral obligations to the secured parties, and return collateral to this account in the event that the obligations to the secured party is reduced or no longer exists. In an embodiment the market accounts 150 may comprise fund custody accounts. In an embodiment, the fund custody accounts may be associated with the futures collateral merchant 130. The timing of such deliveries of free eligible collateral may vary across embodiments, and is described in greater detail below. It may be appreciated that where eligible collateral is not available, an external system may be notified to seek eligible collateral across system s external to the securities intermediary 110, and wait for receipt of eligible collateral,

In an embodiment, the dealer 125 may send instructions to the securities intermediary 110 regarding the collateral movement. In some embodiments the instructions may be transmitted electronically, including but not limited to via facsimile or via a network. In an embodiment, the instructions may include the custodian account number, a fund identifier, trade details and/or settlement instructions. In an embodiment, the trade details may include one or more of a transaction type, purpose, executing broker, settlement dates. International Securities Identification Number (ISIN), description of the security, and coupon, maturity, face, and/or settlement amounts. In some embodiments, the dealer 125 may provide authorization or validation information to the securities intermediary 110, including but not limited to signature information (e.g., confirmatory indicia). In an embodiment, if the instructions involve a collateral recall, as described in greater detail below, the collateral management system 100 may be configured to validate the recall instructions with the dealer 125, including by facilitating manual communication between users of the collateral management system 100 at the securities intermediary 110 and users of the collateral management system 100 at the dealer 125.

In an embodiment, delivering collateral from the market accounts 150 to the securities intermediary 110 may include the securities intermediary 110 validating or authorization information. If the authorization or validation information is invalid, then the securities intermediary may inform the dealer 125 of the invalidity, and refuse the transfer. In an embodiment, informing of the invalidity may comprise transmitting invalidity information over the network. In an embodiment, the invalidity information may include a notification of a voiding of the transfer request associated with the validating or authorization information. In an embodiment, the dealer 125 may subsequently repeat the request (e.g., with corrected validating or authorization information). If the validation information is valid, then the securities intermediary 110 may process the RVF, such as on a custody platform or subsystem associated therewith, and send the trade to the market of a global settlement platform. In some embodiments, the verification may be automatic, based on comparison of the RVF with established rules or standards, while in other embodiments the custody platform or subsystem may prompt users of the collateral management system for manual verification or approval. In an embodiment, the securities intermediary 110 may notify the dealer 125 of the status of the trade, In an embodiment, the trade may then be auto verified in the global settlement platform.

Once the trade is sent to market, the counterparty to the trade (e.g., the pledgor) may then monitor the trade, Once the counterparty has delivered the securities, the securities intermediary 110 may settle the RVF in an associated account. In an embodiment, if there is a mismatch in the delivered securities versus those authorized to be traded, or if there is a lack of instructions from the pledgor the securities intermediary 110 may update the custody platform to indicate reasons why the RVF cannot settle. In an embodiment, this may allow participants, including those operating collateral servicing subsystems at the securities intermediary, to identify whether the collateral allocation may proceed (as described in greater detail below). As shown at 160 in FIGS. 1A and 1B, the delivery of the collateral may be to a collateral market account 170 (e.g., a collateral nominee account) associated with each fund. In an embodiment, the collateral market account 170 may be at the securities intermediary, and may be utilized by the collateral management system 100 to hold the collateral at the market level that is allocated by a pledgor to various secured parties. In an embodiment the collateral management system 100 may utilize the collateral market account 170 to maintain the sum of collateral that are allocated to various secured parties at a market level for each pledgor.

If the collateral is being recalled from the securities intermediary, then in some embodiments the securities intermediary 110 may check and validate authorization/validation information in the request to recall the collateral. If the authorization/validation information is valid, then in some embodiments further verification with the dealer 125 may be performed. If the authorization/validation information is invalid, or if the further verification with the dealer 125 cannot be performed, then in some embodiments the securities intermediary 110 may be prompted to manually secure authorization and verification with the dealer 125 (including, for example, arranging a phone call between users of the collateral management system 100 at the securities intermediary 110 and users of the collateral management system 100 at the dealer 125), so that the dealer 125 may take corrective action with regard to the request to recall collateral from the securities intermediary 110. In some embodiments, recalls may be limited. For example, in one non-limiting embodiment there may be a limit of two recall instructions per day per fund,

In an embodiment, if the authorization/validation information is correct (and in some such embodiments, if the further verification with the dealer 125 is successful), then the securities intermediary 110 may process the DVF on the custody platform. In an embodiment, the securities intermediary 110 may notify the dealer 125 of the status of the processing. In an embodiment the DVF is sent to the market on the condition that a collateral account of the secured party 140 remains fully covered/collateralized. In an embodiment, verifying that the collateral account of the secured party 140 will remain fully covered may be performed by the securities intermediary 110. In an embodiment, if the recall would cause a shortfall, the DVF might not be released to the market, and the securities intermediary 110 may notify the dealer 125, requesting either additional collateral or cancelling the recall request. In an embodiment, if there would be no shortfall with the recall request, the securities intermediary 110 may de-pledge the positions, then verify the trade on the global settlement platform (e.g., via the custody platform) , and manually release the DVF to the market. In an embodiment, the securities intermediary 110 may monitor the trade, and settle the DVF in the account once delivery has been made.

As shown in FIGS. 1A and 1B, once the collateral has been delivered into the collateral market accounts 170, the securities intermediary 110 may monitor the global settlement platform to apply indicators that securities are pledged. Specifically, the securities intermediary 110 may pledge securities on the custody platform so that collateral allocation can proceed to cover the lock-up amount described above. In an embodiment, as the collateral is flagged as pledged, the collateral may be locked up in the global settlement platform accounts (e.g., collateral nominee accounts) so that the collateral may be prevented from being released through automatic processing of recalls and substitutions.

As an example of the delivery/recall process according to some embodiments, it may be appreciated that to secure a deal, the secured party 140 may book a deal with the securities intermediary 110 (e.g., through a user interface, such as AccessEdge). The dealer 125 may then send instructions and deliver a quantity of the collateral. The securities intermediary 110 may then provide instructions and take the positions in. After settlement, the securities intermediary may pledge the positions. The positions may be allocated to the secured party 140, thus securing the deal. If a recall comes in, then in an embodiment the dealer 125 and the secured party 140 might not change the exposure figure. If the dealer 125 sends in a request recalling some collateral and delivering other collateral, then the recalled collateral may be moved from an investor account for the secured party 140 into a lock-up account. Again, the secured party 140 may remain secured, as the collateral in the investor account and lock-up account together collateralize the secured party 140, because they are in the name of the secured party 140, Once additional collateral settles or is available, the recall may be released. The dealer 125 may instruct delivery of the other collateral, which may settle and be pledged in the global settlement platform. The other collateral may be allocated from the dealer box into the investor account of the secured party 140, fully securing the deal. The securities intermediary 110 may then de-pledge the originally recalled collateral (which may be subject to verification first). In an embodiment the recalled collateral may then be automatically removed from the lock-up account once it settles back with the dealer 125.

As shown, the collateral in the collateral market accounts 170 may be processed through collateral allocations and processing 180, and linked to Individually Segregated Accounts (ISAs) 190 associated with pledgor (e,g., the end client 120 or the dealer 125). The collateral allocations and processing 180 may include one or more of, recall and substitution processing allocations, optimizations, eligibility screening, and rule sets, such as those described below,

In an embodiment, separate ISAs 190 may be provided for each pledgor, each with ISA 190 including an associated dealer box. In other embodiments, a common ISA 190 may be provided, having a plurality of dealer boxes therein, associated with collateral for each pledgor, As shown in FIG. 1A, in an embodiment a first ISA 190 may be an account on behalf of a first secured party. In an embodiment, the ISA 190 may be used to maintain collateral obligations that a pledgor has to a secured party. In an embodiment, a second ISA 190 may be on behalf of the first secured party for the benefit of a second secured party. In an embodiment, the collateral obligation the pledgor has may be to more than one secured party. For example, in the case of OTC derivatives trades where a pledgor has conducted a derivatives trade via an futures commission merchant at a central clearing counterparty, the initial margin required for the trade may be posted to an ISA 190 where the central clearing counterparty is the secured primary party and the futures commission merchant is the secondary secured party. In an embodiment, the obligation amounts for the ISA 190, including eligibility, may be determined by the central clearing counterparty, or a combination of the central clearing counterparty and the futures commission merchant. In an embodiment a third ISA 190 may be on behalf of a plurality of secured parties. For example, while the secured party may be a singular entity with whom the pledgor has conducted a financial transaction, the ISA 190 may be from the pledgor to each of a combination of secured parties (e.g., permutations of the futures commissions merchants and the central clearing counterparties) where each secured party pairing may have its own ISA 190 to which the pledgor fulfills its obligations.

The securities intermediary 110 may allocate and lock-up collateral in the ISAs 190 associated with the secured party 140. In an embodiment, the allocation and locking up of the collateral may be via an applied allocation rule-set in the collateral allocations and processing 180. It may be appreciated that separate allocation rule-sets may be associated with each ISA 190, such as is shown in the separate collateral engines 192 of FIG. 1B, in other embodiments a common allocation rule-set may be applied for all ISAs 190. As such, a collective allocation rule can be set up to be applied to all fund accounts associated with the pledgor. In an embodiment, the allocation via the collateral allocations and processing 180 may be performed daily, while in other embodiments, the allocation may be performed periodically, either multiple times a day, or over any number of days. In an embodiment, the collateral allocations and processing 180 may comprise performing the allocation optimizations described in U.S. patent application Ser. No. 13/163,039 or U.S. patent application Ser. No. 13/362,980, incorporated herein in their entireties by reference.

As further shown in FIGS. 1A and 1B, in some embodiments a pledgor (e.g., client) and a futures commission merchant (e.g., secured party) may have agreed to maintain excess collateral outside of the central clearing counterparty in a segregated manner. Accordingly, in an embodiment the collateral allocation system 100 may include an excess collateral account 194, which may store such excess collateral, which may be useful in the case of cleared derivative trades or other such financial transactions. Additionally or alternatively, in some embodiments in the case of cleared derivatives trades, a secured party who may be a futures commission merchant may establish a dealer omnibus cash account 196 at the securities intermediary 110 to meet maintenance and variation margin and calls to a counterparty of the secured party, who may be a central clearing counterparty. In an embodiment, the collateral management system 100 may utilize the dealer omnibus cash account 196 to fulfill any obligations that the pledgor may have to the secured party for variation margin purposes, by posting the appropriate required mounts from the pledgor's market account 150 to the dealer omnibus cash account 196. In an embodiment, a secured party who may be a central clearing counterparty may establish a central clearing counterparty omnibus cash account 198 at the securities intermediary 110 to receive therein variation and maintenance margin requirements from a futures commission merchant. In an embodiment the collateral management system 110 may utilize the central clearing counterparty omnibus cash account 198 to meet the obligation amounts of the future commission merchant at the central clearing counterparty.

It may be appreciated that in some embodiments, the securities intermediary 110 may provide the dealer 125, the futures commission merchant 130, and/or the secured party 140 with online custody reporting and collateral reporting. Such reporting may be provided via electronic messaging to users of the collateral management system 100, or through user interfaces (e.g., and internet based website). In an embodiment, a user interface may be configured to provide real-time collateral reporting, or reporting with a short (e.g., less than 1 hour) delay for report computation. In an embodiment, the securities intermediary 110 may provide to the dealer 125, for example, intra-day monitoring of holdings and the status of individual trades and allocations. In an embodiment, a graphical user interface may provide users of the collateral management system 100 detailed price reports, which may include specific details of the allocated collateral. Such details may include, for example, the ISIN, par amount, and/or the market value of the collateral.

In some embodiments, messaging between the securities intermediary 110, the dealer 125 (and/or the end clients 120), the futures commission merchant 130, and/or the secured party 140 may be accomplished through SWIFT messages. For example, SWIFT (MT558/MT569) messages may be utilized for communications from the securities intermediary 110. SWIFT (MT558) provides valuation results as well as the status of the collateral instructions ant the states of the proposed collateral movements. SWIFT (MT569) is sent after all collateral movements have been affected to show the end (fixed) positions (e.g., the current status). SWIFT In an embodiment, SWIFT (MT527) messages may be transmitted between the secured party 140 and the futures commission merchant 130. For example, in an embodiment the secured party 140 may send deal information to the securities intermediary 110 via SWIFT (MT527). If the dealer 125 bilaterally affirms the terms, the dealer 125 may affirm the terms of the secured party 140 to the securities intermediary 110 via SWIFT (MT527). For initiating the transfer of collateral between the end clients 120 (via the dealer 125), the securities intermediary 110 may receive SWIFT (MT540) for receive free of payment. For initiating a recall, the securities intermediary 110 may receive SWIFT (MT542) to deliver free of payment. Other messaging or standardized formats for data and financial transfers may additionally or alternatively be utilized in some embodiments, and those disclosed herein are not intended to be limiting.

In the processes described above, the securities intermediary 110 creates accounts for the end clients 120 of the dealer 125. It may be appreciated, however, that in some embodiments the end clients 120 may themselves have collateral in a custody account at the securities intermediary. In some such embodiments, intraday rehypothecation, such as is described in U.S. Provisional Patent Application Ser. No. 61/748,633, incorporated herein in its entirety by reference, may enable the collateral to be directly allocated to the secured party 140, without having to set up a separate margin account at the global settlement platform. In an embodiment, such utilization of already-present collateral may be enacted if the assets are fully paid for and unencumbered.

It may be appreciated that in an embodiment reporting and messaging to one or more parties may be provided by systems described herein. For example, in an embodiment a graphical user interface (which may include report download capability) may provide real-time views of position holdings to relevant parties (including but not limited to one or more of end clients, futures commission merchants, central clearing counterparties, the securities intermediary, internal and external compliance and audit parties, and/or regulators). In an embodiment, account access may be at the individual client account level for the respective clients. If a client has multiple accounts they may be able to view all accounts associated to them.

In an embodiment, managerial parties (e.g., the dealers) may be able to view accounts for their underlying clients across futures commission merchants and central clearing counterparties. Futures commission merchants may be able to view all their underlying clients across central clearing counterparties. Central clearing counterparties may be able to view all their underlying accounts across futures commission merchants and end clients. In an embodiment, notification messages pertinent to collateral processing may follow industry standard SWIFT formats and must have the flexibility to address bulk file uploads for inputs on collateral processing and SFTP capabilities for reporting outputs and processing of bulk uploads for inputs. In an embodiment, movements of cash and securities in or out of an individual segregated account (e.g., a shell account) may be tracked in a transactions journal and may be reported on in the sequence of activity that has been enacted upon the accounts. In an embodiment, transactions journal history may be maintained for any appropriate amount of time, In an embodiment, matching and allocation confirmation messages may be provided generally in real-time, with allocation details being sent to one or more of end clients, futures commission merchants, and the central clearing counterparty/secured party. In an embodiment, end of day reports may be made available or may be sent to associated parties, and may include positions, amounts, and/or details specific to a safekeeping account, including but not limited to one or more of matching of instructions for allocations, recalls, and/or substitutions that have been processed.

In an embodiment, details on the margin segregated account (including, for example reflecting items in the dealer box and the safekeeping account may be provided to clients of the dealer. As a manager the dealer may request for client reporting in aggregate in some embodiments. In an embodiment, the futures commission merchants and /or the central clearing counterparties may likewise request aggregate reporting. In an embodiment, futures commission merchants, central clearing counterparties, and end clients may request ad-hoc reporting, which may extend to spot checks by other parties, as well who have authorized access to the accounts,

In an embodiment, default instructions processing provided by the systems described herein may include an automation capability to receive the notices of exclusive control and capabilities to enact those notices. In an embodiment, relevant parties may be notified via an automated default instruction processing module. In an embodiment, once the notice has been verified, all collateral processing activity specific to all the accounts for which the notice applies to may stop. In an embodiment, collateral (including cash & securities) from safekeeping accounts to which the notice applies may be immediately and/or automatically moved into a default event processing account for a secured party. In an embodiment, collateral (cash & Securities) in the margin segregated account might not be affected by the notice. Once all the required collateral has been gathered into the secured party's default event processing account, it may be delivered to the appropriate location as per the instructions on the default notice. In an embodiment, client accounts may be ported to another futures commission merchant or another central clearing counterparty. It may be appreciated that in some embodiments, account property may be directed to locations other than the secured party's default event processing account.

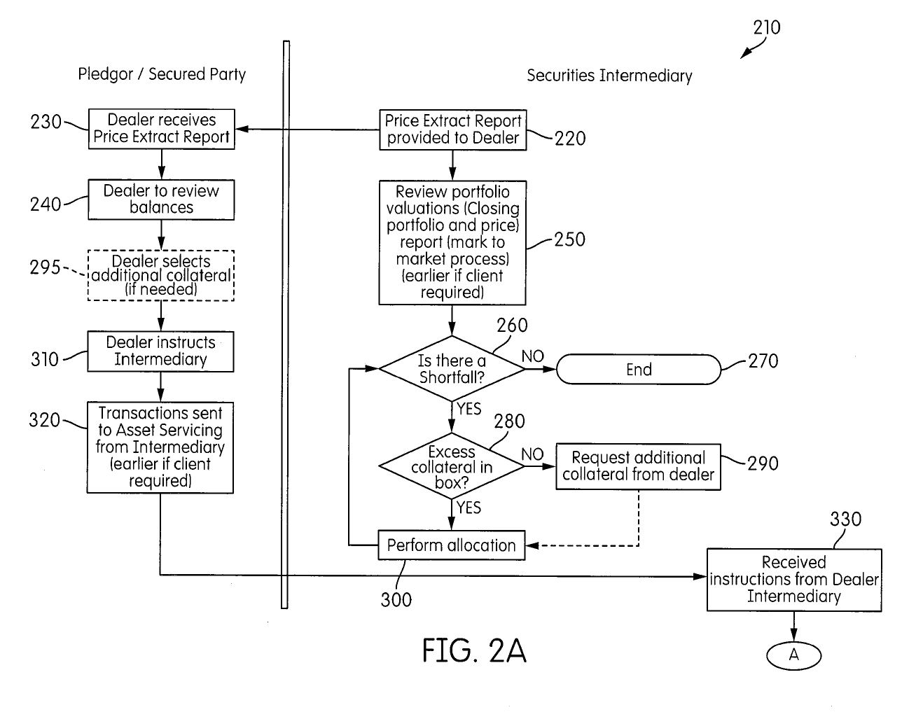

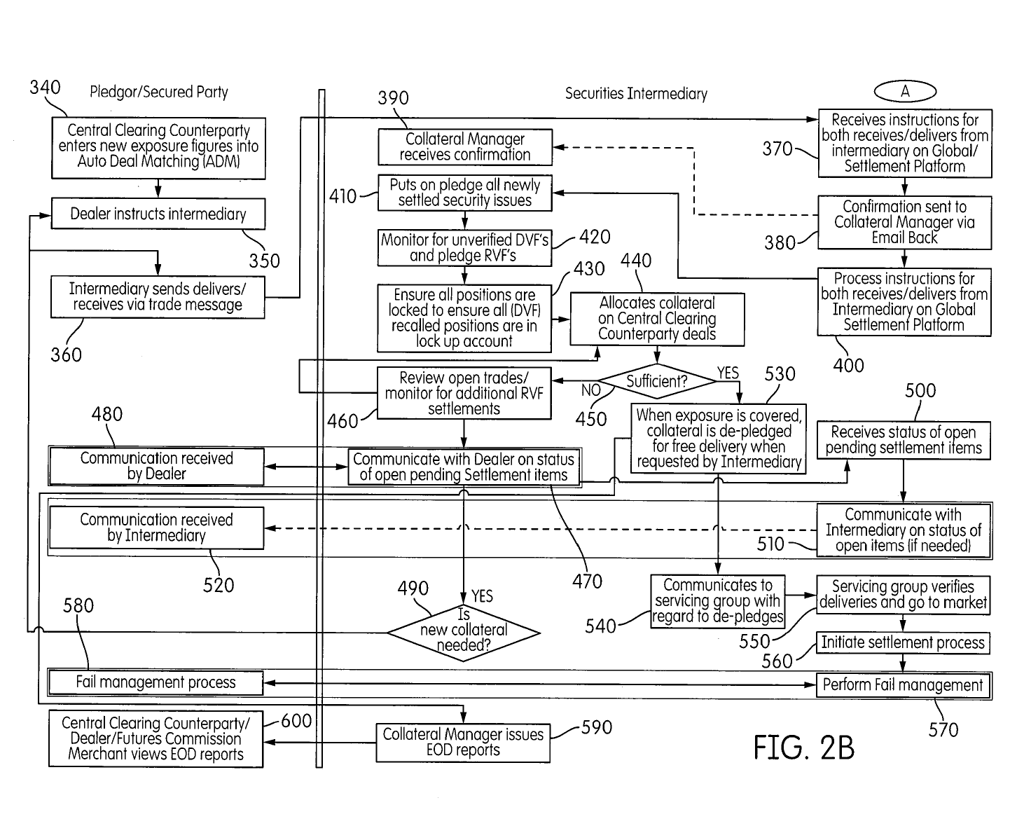

FIGS. 2A and 2B illustrate an embodiment of a process workflow 210 implemented via embodiments of the collateral management system 100. As shown, the securities intermediary 110 may be viewed as including a collateral manager component and an asset servicing component. It may be appreciated that these components may operate on separate subsystems in the collateral management system 100, or may be different facets of the same system. In some embodiments, features of the workflow 210 may be the same as or similar to the descriptions made with reference to FIGS. 1A and 1B above.

As shown in FIG. 2A, in an embodiment the securities intermediary (as collateral manager) may at 220 provide a price extract report to the pledgor, which is received at 230, As shown, the pledgor may then review balances from the price extract report at 240. In an embodiment the securities intermediary may review portfolio valuations (closing portfolio and price) perform reporting (mark to market process), at 250. In an embodiment, it may be determined at 260 if there is a shortfall determined following the review at 250. If there is no shortfall, then the morning processing by the securities intermediary may end at 270. If there is a shortfall, then it may be determined at 280 whether there is excess collateral in the account/box. If there is not, then additional collateral may be requested from the pledgor at 290. If there is excess collateral at 280, or once additional collateral is received from the pledgor (e.g., as indicated at 295), then the allocation may be performed at 300. The securities intermediary (as collateral manager) may then determine if a shortfall continues to exist, by returning to 260. While this is ongoing, the dealer may instruct the pledgor at 310 in response to the review of balances based on the price extract report so that if there is a collateral shortfall the pledgor delivers the collateral and the securities intermediary allocates it. The intermediary may at 320 then send the transactions to the securities intermediary (as asset servicer) at 320, which may be received at 330.

Continuing at FIG. 2B, the central clearing counterparty may transmit exposure figures to the securities intermediary at 340 by sending them to an auto deal matching component thereof. As shown, the pledgor may subsequently instruct the intermediary at 350 regarding substitutions and recalls, and the intermediary may transmit the instructions for deliverables and receivables to the asset servicing component of the securities intermediary. As shown, the securities intermediary (as asset servicer) may receive the instructions for both receivables and deliverables from the intermediary on the global settlement platform, at 370.

At 380, confirmation of the receivables/deliverables may be sent to the collateral manager aspect of the securities intermediary (received at 390). The asset servicer component of the securities intermediary may then process instructions for the receivables and deliverables on the global settlement platform, at 400, and the collateral manager component may pledge the newly settled security issues at 410. The collateral manager component may subsequently monitor the global settlement platform for unverified DVFs, and pledge RVFs, at 420. The collateral manager component may also, at 430, ensure the positions are locked to ensure that DVF recalled positions are in a lock-up account. As shown, the collateral manager may then allocate collateral on the central clearing counterparty deals at 440. It may be determined at 450 whether the collateral is sufficient.

If the collateral is insufficient at 450, then open trades may be reviewed and monitored at 460 for additional RVF settlements, and the collateral may be reallocated by returning to 440. Additionally, the collateral manager aspect of the securities intermediary may communicate with the pledgor on the status of open pending settlement items, at 470 (the communication being received by the pledgor at 480). If new collateral is needed at 490, then the pledgor may instruct the intermediary of such by returning to 350. As the collateral manager aspect of the securities intermediary is communicating with the pledgor at 470, the asset servicing component may at 500 receive the status of the open pending settlement items, and at 510 may communicate with the intermediary on the status of open items (if needed, the communication being received by the intermediary at 520).

If the collateral is sufficient at 450, then when exposure is covered, the collateral may be de-pledged at 530 for free delivery when requested by the intermediary. The collateral manager may then communicate at 540 with the asset servicing component with regard to de-pledges (e.g., collateral being available for the pledgor), and the asset servicing component may verify deliveries and go to market at 550. The asset servicing component may subsequently initiate a settlement process at 560.

In the illustrated embodiment, the asset servicing component of the securities intermediary may perform fail management at 570, wherein if a security fails to settle, a reconciliations process may be instituted. As shown at 580, this may be performed in conjunction with the other participants utilizing the collateral management system. Additionally, the collateral manager may issue an end of the day (EOD) report at 590, which may be viewed by the other participants at 600.

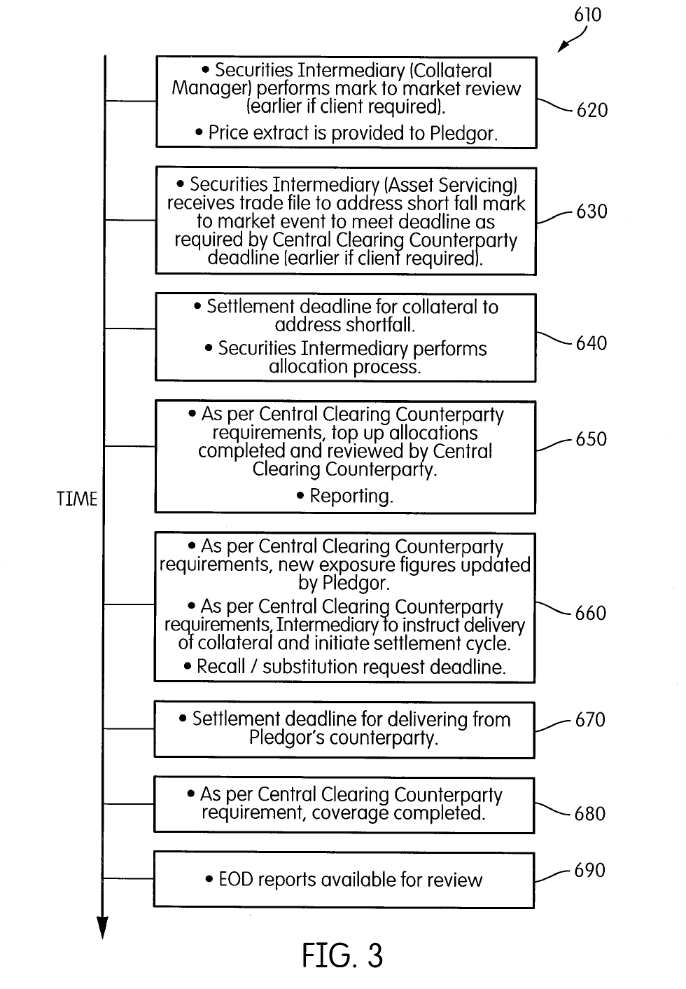

FIG. 3 illustrates another exemplary process flow 610, which shows an embodiment of how the various actions may be structured throughout a trading day. For example, the exemplary process flow 610 may begin at 620, where the collateral manager may perform a mark to market review, and the price extract may be provided to the pledgor. At 630, an asset servicing component of the securities intermediary may receive the trade file to address a shortfall mark-to-market event. It may be appreciated that the timing of this may be configured to meet any timing requirements imposed by the central clearing counterparty. As shown at 640, shortfall may then be addressed and settled. In an embodiment, the pledgor may deliver collateral to the securities intermediary to cover any mark-to-market shortfall for a prior day agreed amount. In some embodiments there may be some excess amount remaining overnight for mark-to-market. The securities intermediary, acting as collateral manager, may perform the allocation processes. At 650, a top up of allocations may be completed and reviewed by the central clearing counterparty. Mid-morning reporting may also be performed in some embodiments. As shown at 660, new exposure figures may be updated by the pledgor. Additionally, the intermediary may instruct delivery of collateral and initiate the settlement cycle. It may be appreciated that a deadline may be imposed to request recalls and substitutions in some embodiments. As shown at 670, delivery from the pledgor's counterparty may then be settled. In an embodiment, coverage may be completed at 680, while end of the day reports may be generated and made available for review at 690.

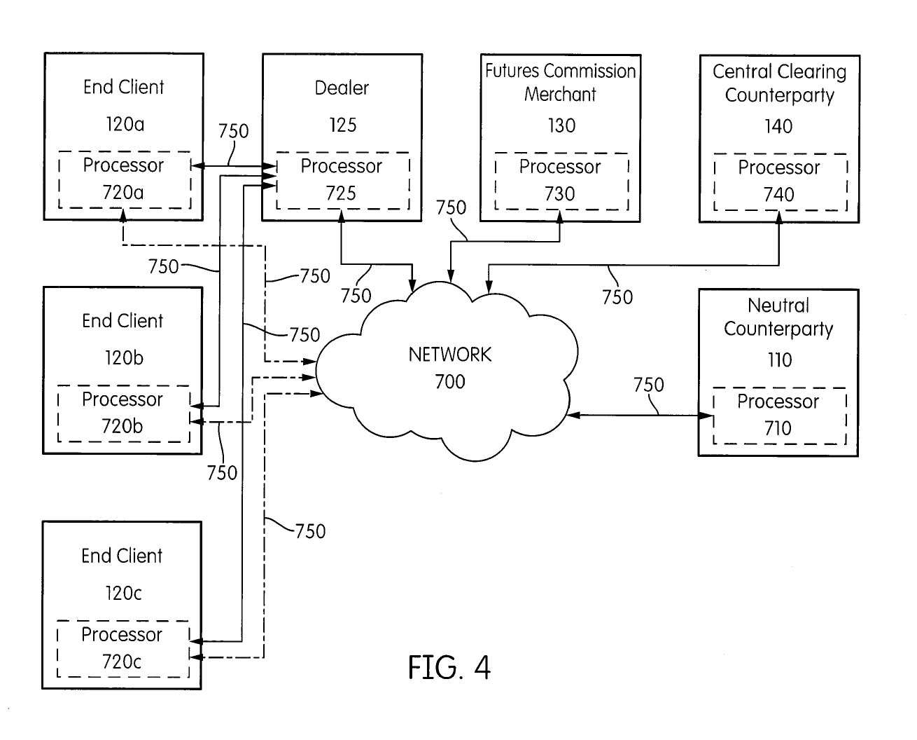

According to various embodiments described herein, the securities intermediary 110, the end clients 120 (e.g., via dealer 125), the futures commission merchant 130, and the secured party 140 may comprise associated computer systems linked through a network interface. As shown in FIG. 4, in an embodiment the system participants may be linked through a network 700. The network 700 may comprise any number of wired and/or wireless communication gateways. In an embodiment, the network 700 comprises or otherwise couples to the internet. In some embodiments, the network 700 may comprise a proprietary network, an intranet, or any other network connection.

In various embodiments each of the system participants may comprise one or more associated processors that link to the network 700. For example, in the illustrated embodiment, the securities intermediary 110 includes a processor 710, on which the system above may operate. The end clients 120 (specifically end clients 120a, 120b, and 120c in the illustrated embodiment) may each comprise associated processors 720 (specifically processors 720a, 720b, and 720c in the illustrated embodiment). Likewise, the dealer 125 may comprise a processor 725, the futures commission merchant 130 may comprise a processor 730, and the secured party 140 may comprise a processor 140. Although a single processor is illustrated with each participant in the system in the illustrated embodiment, it may be appreciated that each participant may also comprise a plurality of processors in one or more systems.

As shown, each participant may be coupled to the network via the one or more processors. In particular the processors may be linked via network connections 750. Such network connections 750 may comprise wired or wireless network connections. As shown in FIG. 4, in an embodiment the network connections 750 between the securities intermediary 110, the dealer 125, the futures commission merchant 130, and/or the secured party 140 may be to each other through the network 700. In some embodiments, separate links between the participants may additionally or alternatively be provided. For example, in the illustrated embodiment, the end clients 120 may connect to the network 700 via the dealer 125. It may be appreciated, however, that in some embodiments the end clients 120 may additionally or alternatively be coupled directly to the network 700 themselves. In some such embodiments, the end clients 120 may couple to the dealer 125 through the network 700 (and the network connections 750 therebetween). It may be appreciated that each participant may provide user interfaces associated with the processors, which may include graphical user interfaces (e.g., configured to display information over a monitor) and/or input interfaces, such as keyboards, mice, touch screens, or so on, thus providing an interface for users of the system to input, receive, and manipulate data associated therewith.

The above-discussed embodiments and aspects of this disclosure are not intended to be limiting, but have been shown and described for the purposes of illustrating the functional and structural principles of the inventive concept, and are intended to encompass various modifications that would be within the spirit and scope of the following claims.

Various embodiments may be described herein as including a particular feature, structure, or characteristic, but every aspect or embodiment may not necessarily include the particular feature, structure, or characteristic, Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What is claimed is:

1. A system for managing collateral in one or more financial transactions, the system comprising one or more processors, at a securities intermediary to the one or more financial transactions, the one or more processors configured to execute one or more computer program modules, the program modules being configured to:
establish an individual segregated account for each of a plurality of pledgors;
receive a lock-up amount from one or more secured parties for one of the plurality of pledgors;
receive a request to post collateral from an account of the one of the plurality of pledgors to the individual segregated account associated with the one of the plurality of pledgors; and
allocate collateral from the account of the one of the plurality of pledgors to the individual segregated account associated with the one of the plurality of pledgors, for the benefit of the one or more secured parties, the collateral being at least equal to the lock-up amount.

2. The system of claim 1, wherein the program modules are further configured to receive a lock-up amount from one or more of the plurality of pledgors, and match the lock-up amount from the one or more secured parties to the lock-up amount from the one or more of the plurality of pledgors

3. The system of claim 1, wherein allocating collateral is based on pre-defined rule sets and eligibility criteria.

4. The system of claim 1, wherein the program modules are further configured to, when the collateral in the associated one of the individual segregated accounts exceeds the lock-up amount, an excess amount of collateral is returned to the pledgor.

5. The system of claim 4, wherein the program modules are further configured to, before returning the excess amount of collateral to the account associated with the pledgor, hold the excess amount of collateral until receiving an instruction to release the excess amount of collateral from the one or more secured parties.

6. The system of claim 1, wherein the one or more secured parties have a plurality of clearing brokers and end clients or pledgors associated therewith.

7. The system of claim 1, wherein the collateral comprises one or more of FED, DTC, Global, Cash, and Mult-Currency collateral types.

8. The system of claim 1, wherein the one or more processors are further configured to perform a mark-to-market review of the one or more financial transactions.

9. The system of claim 8, wherein the one or more processors are further configured to receive additional collateral from the one of the plurality of pledgors to address a shortfall, and post the additional collateral in the associated one of the individual segregated accounts.

10. The system of claim 8, wherein the one or more processors are further configured to receive additional collateral from the one of the plurality of pledgors to address substitutions from the individually segregated account while maintaining the lockup amount and eligibility criteria.

11. The system of claim 1, wherein each individual segregated account is associated with a cleared over-the-counter derivatives trade initial margin obligation or other collateral obligations for financial transactions where segregation of collateral is required of each of the plurality of pledgors.

12. The system of claim 11, wherein the cleared over-the-counter initial margin obligation is for trades cleared via the futures commission merchant as a clearing member at the one or more secured parties, acting as a central clearing counterparty.

13. The system of claim 1, wherein the one or more processors are further configured to transmit the lock-up amount to the one of the plurality of pledgors for confirmation.

14. The system of claim 1, wherein the plurality of pledgors are clients of a dealer, and wherein the one or more processors are configured to receive the request to post collateral from one of the plurality of pledgors via the dealer.

15. The system of claim 14, further comprising an intermediary between the securities intermediary and the dealer, the intermediary being configured to deliver the collateral to the securities intermediary.

16. A computer implemented method for managing collateral in one or more financial transactions, wherein the method is implemented in a computer system comprising one or more processors configured to execute one or more computer program modules, the method comprising:
establishing, via the one or more processors, at a securities intermediary to the one or more financial transactions, an individual segregated account for each of a plurality of pledgors;
receiving, via the one or more processors, a lock-up amount from one or more secured parties for one of the plurality of pledgors;
receiving, via the one or more processors, a request to post collateral from an account of the one of the plurality of pledgors to the individual segregated account associated with the one of the plurality of pledgors; and
allocating collateral from the account of the one of the plurality of pledgors to the individual segregated account associated with the one of the plurality of pledgors, for the benefit of the one or more secured parties, the collateral being at least equal to the lock-up amount.

17. The method of claim 16, further comprising receiving a lock-up amount from one or more of the plurality of pledgors, and matching the lock-up amount from the one or more secured parties to the lock-up amount from the one or more of the plurality of pledgors.

18. The method of claim 16, wherein allocating the collateral is based on pre-defined rule sets and eligibility criteria.

19. The method of claim 16, further comprising when the collateral in the associated one of the individual segregated accounts exceeds the lock-up amount, allocating, via the one or more processors, collateral to an account associated with the pledgor.

20. The method of claim 19, further comprising, before allocating the excess amount of collateral to the account associated with the pledgor, holding the excess amount of collateral until receiving an instruction to release the excess amount of collateral from the one or more secured parties.

21. The method of claim 16, wherein the one or more secured parties have a plurality of clearing brokers associated therewith.

22. The method of claim 16, wherein the collateral comprises one or more of FED, DTC, Global, Cash, and Mult-Currency collateral types.

23. The method of claim 16, further comprising performing a mark-to-market review of the one or more financial transactions.

24. The method of claim 23, further comprising receiving additional collateral from the one of the plurality of pledgors to address a shortfall, and post the additional collateral in the associated one of the individual segregated accounts.

25. The method of claim 16, wherein each individual segregated account is associated with a cleared over-the-counter derivatives trade initial margin obligation or other collateral obligations for financial transactions where segregation of collateral is required of each of the plurality of pledgors.

26. The method of claim 25, wherein the cleared over-the-counter initial margin obligation is for trades cleared via the futures commission merchant as a clearing member at the one or more secured parties, acting as a central clearing counterparty.

27. The method of claim 16, further comprising transmitting the lock-up amount to the one of the plurality of pledgors for confirmation.

28. The method of claim 16, wherein the plurality of pledgors are clients of a dealer, and wherein receiving the request to post collateral from one of the plurality of pledgors is via the dealer.

29. The method of claim 28, wherein the securities intermediary is configured to receive the collateral from an intermediary configured to send the collateral at the request of the dealer.
